(19) United States
(12) Patent Application Publication
(10) Pub. No.: US 2016/0219358 A1
(43) Pub. Date: Jul. 28, 2016

(54) WIRELESS EARBUDS WITH RECIPROCATING LEADER AND FOLLOWER CONFIGURATION

(71) Applicant: Alpha Audiotronics, Inc., New York, NY (US)

(72) Inventors: Jonathan Everett Shaffer, Huntingdon Valley, PA (US); Jamie Robert Seltzer, New York, NY (US)

(21) Appl. No.: 15/009,092

(22) Filed: Jan. 28, 2016

Related U.S. Application Data
(60) Provisional application No. 62/108,690, filed on Jan. 28, 2015.

(51) Int. Cl. H04R 1/10; H04R 29/00; H04R 3/12

(52) U.S. Cl. CPC H04R 1/1041; H04R 1/1016; H04R 3/12; H04R 29/001; H04R 2420/07

(57) ABSTRACT

Two wireless earbuds include controllers, receivers, transmitters and firmware. One earbud establishes a primary wireless communication connection to an electronic device such as a smart phone, and a secondary wireless communication connection to a second earbud. Power monitors, signal strength monitors, synchronized clocks, and power management hardware and/or software may trigger a switching condition to occur. Each switching condition causes the reversal of the roles of the first and second earbuds so as to increase the operating life of the paired earbuds before they need to be recharged by balancing their respective power consumption when in use. Each switching condition may also cause the reversal of the roles of the first and second earbuds so as to avoid the disconnection of communication with the electronic device and/or evenly distribute battery usage.

### RELATED APPLICATIONS

This application claims priority to U.S. Provisional Patent Application Ser. No. 61/108,690, filed Jan. 28, 2015, the contents of which are incorporated herein by reference in its entirety.

### BACKGROUND

This disclosure relates to wireless earbuds, and more particularly relates to wireless earbuds with reciprocating leader and follower configuration.

Wireless earbuds are a convenient way to eliminate the issues associated with physical user connection to audio signal producing devices. The existing wireless headphones in the marketplace are tethered such that one of the earbuds (the “leader”) contains an embedded receiver, microchip, battery and control functions and is linked wirelessly to the data producing device (i.e. a cellular phone playing music). The second earbud (the “follower”) receives electrical charge and data from the first earbud via physical wiring. In this way, one of the earbuds may be considered to be primary, and the other secondary. In addition to “leader/follower” or “primary/secondary,” such a configuration is sometimes also called a “master/slave” or “primary/replica” configuration.

In a truly wireless earbud configuration, there is no physical wiring at all. The leader earbud contains the same components described previously. The follower earbud may be identical to the leader earbud and (a) contains its own internal battery for power, and (b) receives data transmitted wirelessly from the first earbud because it is not physically connected to the leader.

In a system with two identical wireless earbuds where one is a follower and the other is the leader, the leader earbud holds primary connection to the original data source. This means that the leader earbud is actively (i) receiving signals from the phone or other electronic device from which it receives transmissions, (ii) transmitting signals to the phone, and (ii) simultaneously transmitting signals to the follower earbud. Given that the leader earbud is actively transmitting and receiving more data, and its internal microchip is producing more calculations, the leader earbud consumes more electrical energy than the follower earbud. Because the earbuds are intended for use in pairs, this creates a problem for the user because the leader earbud will exhaust its electrical energy while the follower earbud still has significant electrical energy remaining.

This document describes a system that may address the issues described above.

### SUMMARY

In an embodiment, an earbud set includes two earbuds: a leader earbud and a follower earbud, each having a transmitter, a receiver, and a controller. The leader earbud is configured to establish a primary communication connection with a remote electronic device and a secondary communication connection with the follower earbud. In such configuration, the leader earbud can transmit/receive audio or data to/from the remote electronic device, process received audio or data, and transmit a part of the audio or data to the follower earbud. The leader earbud may also receive data from the follower earbud and pass on to the remote electronic device. The leader earbud is also capable of detecting a switching condition, and if a switching condition has occurred, sending a signal to the follower earbud to establish a primary communication connection with the remote electronic device, and terminating its own primary communication connection with the remote electronic device, thus to relinquish the leader role and become a follower earbud. The follower earbud may be configured to receive a switching signal, and in response to receiving the switching signal, establish a primary communication connection with the remote electronic device and assume a leader role.

Optionally, each of the two earbuds in the set may be configured to include at least some components that are identical. An earbud, once taking the leader role, may detect that a switching condition has occurred, and in response, send a signal to the other earbud to establish or re-establish the primary communication connection with the remote electronic device, and terminate its own communication connection with the remote electronic device, thus to relinquish the leader role and become a follower earbud.

There may be various ways to detect that a switching condition has occurred. In one embodiment, each earbud includes a power monitor that is configured to detect a battery charge level in the earbud, and the switching condition may be indicative of a difference between a battery charge level in the leader earbud and a battery charge level in the follower earbud. Using this switching condition, the earbud that has the most remaining battery charge will be the leader and the other earbud the follower. The switching condition may also be indicative of a decrease of a battery charge level in the leader earbud as compared to a previous battery charge level. The system also may include a clock circuit, and the switching condition may also be indicative of an elapsed period of time since a previous switching has occurred, or may occur at a fixed frequency.

Alternatively and/or additionally, each of the earbuds in the set may also include an antenna control that can be configured as a communication signal monitor to detect the level of communication signal strength, such as Bluetooth signal strength, received by the earbud for a communication connection with the remote electronic device. In one embodiment, the switching condition is indicative of the difference between the level of communication signal strength in the leader and follower earbuds. Using this switching condition, the earbud that receives the strongest signal for communicating with the remote electronic device will be the leader and the other earbud the follower. The switching condition may also be indicative of a decrease of the level of communication signal strength by at least a threshold amount as compared to a previous communication signal strength level in the leader earbud.

### BRIEF DESCRIPTION OF THE DRAWINGS

FIG. 1 illustrates diagrams of various electrical components within a set of wireless audio earbuds.

FIG. 2 illustrates diagrams of select components and microchips contained within the earbuds from FIG. 1.

FIG. 3 is a diagram of the wireless data connection between the earbuds from FIG. 1 and a mobile computing device according to one embodiment.

FIG. 4 illustrates a relationship between the two earbuds in FIG. 1 according to one embodiment.

FIG. 5 illustrates a reverse relationship between the two earbuds in FIG. 1 according to one embodiment.

FIG. 6 illustrates a diagram of reversal between a leader earbud and a follower earbud according to one embodiment.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

The term “connected,” when used to refer to a relationship between two earbuds or between an earbud and an electronic device, refers to a configuration in which the two items have established a communication link by which they may exchange signals containing data. The link may be a near-field or short-range communication link, such as may occur when two devices “pair” using a Bluetooth or other communications protocol.

Each of the terms “electronic device,” “remote electronic device,” “mobile electronic device” and “mobile computing device” refers to a computing device that includes a processor and non-transitory, computer-readable memory. The memory may contain programming instructions in the form of a software application or firmware that, when executed by the processor, causes the device to be in wireless communication with another device or peripherals, such as a headset or earbud, and perform various processing operations according to the programming instructions. Examples of suitable devices include portable electronic devices such as smartphones, personal digital assistants, cameras, tablet devices, remote controllers, electronic readers, personal computers, media players, satellite navigation devices and the like. The wireless communication can be in various protocols such as Wi-Fi, Bluetooth, NFC (Near Field Communication), other RF- or infrared-based protocols or the like, or other wireless protocols, now known or later developed.

Each of the terms “earbud” and “earphone” refers to a device designed to fit within the ear of a human, and which emits audio signals that the earbud receives from an electronic device. Examples of earbuds include ear-anchored headphones, audio headsets with microphones, and in-ear speakers. Examples of earphones include in-ear headphones, hearing aids and the like. Earbuds or earphones also may include or be components of other audio devices such as wireless headsets, in-ear monitors and the like.

The “leader” earbud in a set of earbuds is the earbud with primary Bluetooth or NFC connection with an audio and/or data transmitting/receiving electronic device. The “follower” earbud is an earbud that receives and/or transmits signal from/to a leader earbud, and that is not directly connected or in communication with the audio/data transmitting/receiving electronic device.

The embodiments described in this document may help eliminate the inconvenience of additional charging cables, wires, and tethered earbuds by providing a configuration of two truly wireless earbuds, with optimized battery life and signal reception for the pair.

This patent document incorporates by reference the following patent disclosures in full: (i) U.S. Provisional Patent Application No. 61/942,698, filed Feb. 21, 2014; (ii) U.S. Pat. No. 8,891,800; (iii) U.S. patent application Ser. No. 14/510,539, filed Oct. 9, 2014; and (iv) U.S. Pat. No. 9,148,717, filed Jan. 23, 2015.

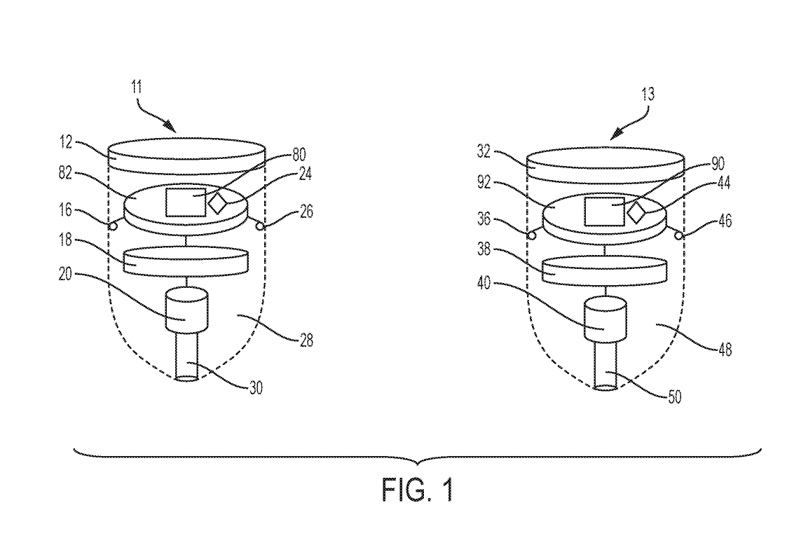

With reference to FIG. 1, an earbud pair or earbud set contains two individual earbuds 11 and 13 that contain earbud batteries 18 and 38 which serve as the primary power source for the earbuds 11 and 13. The earbud batteries 18 and 38 may be non-rechargeable as available commercially off-the-shelf. In one embodiment, the earbud batteries 18 and 38 may be rechargeable batteries and may be charged through direct current, induction, or other near-field charging methods. The earbuds 11 and 13 may also contain one or more micro-controllers or processors 80 and 90, antennas 24 and 44, and other components such as transmitters and receivers. These components, including the micro-controllers or processors, are electrically coupled, such as mounted on and electrically connected via a circuit on each earbud's respective printed circuit board (PCB) 82 and 92, so that the micro-controllers or processors 80 and 90 can control various other components in order to communicate with another earbud or a remote electronic device. These various electrical components and circuitry in each earbud are powered primarily by the earbud batteries 18 and 38. Antennas 24 and 44 provide earbuds 11 and 13 with the ability to communicate with each other or with a remote electronic device, e.g. a mobile smart phone, wirelessly, such as using Bluetooth, or near-field communication capabilities.

The earbuds 11 and 13 may be configured to receive signals via antennas wirelessly, where the signals may contain data representing digital audio such as voice or music, and/or control signals for causing the microcontrollers 80 and 90 to perform certain control operations. In one embodiment, each of the controllers 80 and 90 receives audio signals, processes the received audio signals and then passes the processed signals on via the electrical circuit to speakers 20 and 40, which in turn produce audible sound. The earbuds 11 and 13 may also include one or more microphones 16, 26 and 36, 46, which are electrically mounted on or connected to each earbud's respective circuit 82 or 92. Microphones may include either analog or digital, or other varieties. In one embodiment, the controllers 80 or 90 can be configured to cause the microphones 16, 26 and 36, 46 to capture sound, process the captured audio signals and transmit the audio signals to an external source device such as a smart mobile phone.

The earbuds may also contain earbud tips 30 and 50, which are coupled to acoustic components of speakers 20 and 40. In one embodiment, the earbud tips 30 and 50 are configured to contact the user's ear canals and allow audible sounds to travel from the speakers 20 and 40 to a user's ears. The earbud tips 30 and 50 may be made from a soft material such as silicone, rubber, resin, photopolymer, foam and the like. In one embodiment, the earbud tips can be produced by injection molding or anatomically customized for a user's ear canal via 3D scanning and/or printing.

In one embodiment, the earbuds may also contain grips 12 and 32, which provide a means for a user to grasp and remove them from the user's ears. As grips do not need to contact a user's ears, they may be made of any plastic such as polycarbonate, polypropylene, polyvinyl chloride, photopolymer, resin, metal, alloy and the like, and available in a variety of hues. The earbuds 11 and 13 may also contain electrical connectors/conductors, such as leads or prongs that can be used for charging or communicating with other devices.

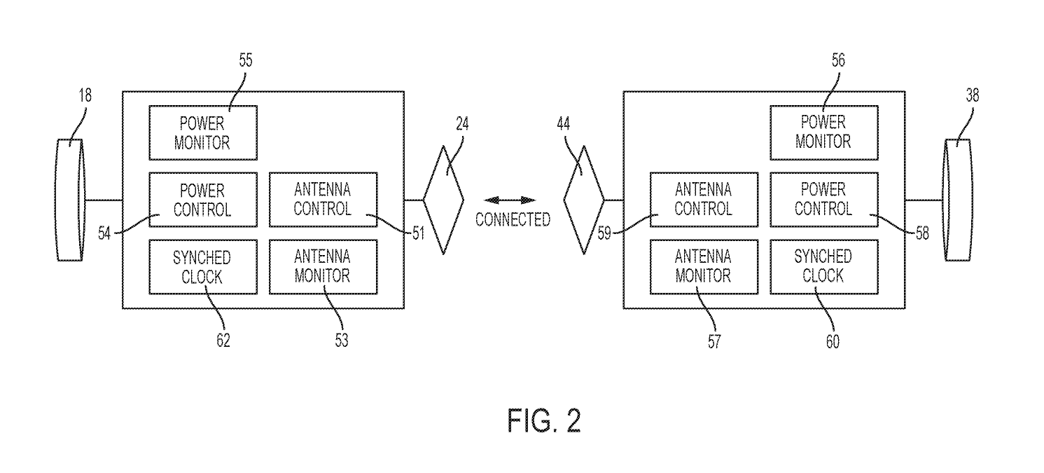

With reference to FIG. 2, select components from the earbud set, i.e. earbuds 11 and 13 in FIG. 1 are shown. The earbuds may contain components such as one or more transmitters and receivers (which may be integrated into a single transceiver device or provided as separate components), Bluetooth and/or WiFi interfaces, RAM, Flash memory, MMUs, as well as embedded software stored in non-transitory computer readable medium for audio signal processing (CODECs), interface management, clock synchronization, power monitoring, power control, antenna reception signal monitoring and a host of other functions.

With further reference to FIG. 2, in an non-limiting example, earbuds 11 and 13 (FIG. 1) of the earbud set can each have an antenna control system 51 and 59 that can be configured to establish a wireless communication connection between the two earbuds via antennas 24 and 44. In one embodiment, the wireless communication connection can be a Wi-Fi channel or a Bluetooth channel. In one embodiment, each earbud can contain a power monitor system 55 and 56 that can be configured to detect the battery charge level in each earbud, such as remnant charge within batteries 18 and 38. The detected battery charge level may be stored in a memory installed in each earbud for later retrieval. In one embodiment, the two earbuds may also each contain a synchronized clock circuit 62 and 66 for each respective controller to share, so that any connection change and audio signal processing between the two earbuds may be coordinated appropriately.

Each earbud can also include a power monitor system 55 and 56 that can be configured to monitor the changes in battery charge level. In one embodiment, a power monitor system in one earbud 55 may obtain the battery charge level of the earbud from the power control system 54. Additionally, the power monitor system 55 may also obtain the battery charge level of the other earbud in the pair from the power control system of that other earbud 58 via the wireless communication connection between the two earbuds. For example, during the wireless communication between the two earbuds, the reading of each earbud's battery charge level can be processed by its respective controller and included in a data packet that will be transmitted to the other earbud. The controller of the receiving earbud may receive the data packet wirelessly and decode the battery charge level from the received data packet and pass it to its own power monitor system. Alternatively and/or additionally, the battery charge level of one earbud may be transmitted to the other earbud via other communication protocols, in either digital or analog.

In one embodiment, the power monitor system 55 and 56 may be configured to constantly or periodically monitor the changes in battery charge level and determine whether a switching condition has occurred. The switching condition may indicate a significant change of conditions, such as the battery charge level or antenna reception signal strength that may affect the continued operation of the earbuds. The occurrence or detection of a switching condition may cause the roles or relationship of the two earbuds to reverse. For example, when the power monitor systems 55 and 56 detect a significant difference in remnant charge of batteries 18 and 38, a switching condition may have occurred, indicating an imbalance of remaining battery charges between the two earbuds that may warrant the roles of the two earbuds to switch.

In one embodiment, the antenna control system 51 and 59 in each of the earbuds can be configured to detect the antenna reception signal strength of each respective earbud for a particular wireless connection, such as to a target or host remote electronic device. For example, each earbud can detect one or multiple Bluetooth target devices (e.g. a remote electronic device or a smart mobile phone) within its reception range and can measure the reception signal strength for each of the connections corresponding to one or more target devices.

Alternatively and/or additionally, each earbud may contain an antenna monitor system 53 and 57, which can be configured to monitor the changes of antenna reception signal strength. An antenna monitor system in one earbud 53 may obtain the antenna reception signal strength of the earbud from the antenna control system 51. The antenna monitor system 53 may also obtain the reception signal strength of the other earbud in the pair from the antenna monitor system of that earbud 57 via the wireless communication connection between the two earbuds. For example, during the wireless communication between the two earbuds, the reading of each earbud's antenna reception signal strength level can be processed by its respective controller and included in a data packet that will be transmitted to the other earbud. The controller of the receiving earbud may receive the data packet wirelessly and decode the antenna reception signal strength level from the received data packet and pass it to its own antenna monitor system.

Alternatively and/or additionally, the antenna reception signal strength level of one earbud may be transmitted to the other earbud via other communication protocols, in either digital or analog Similar to power monitor system 55 and 56, antenna monitor system 53 and 57 can be configured to constantly or periodically monitor the changes of antenna reception signal strength level of the two earbuds and determine whether a switching condition has been met, which condition may warrant the roles of the two earbuds to switch.

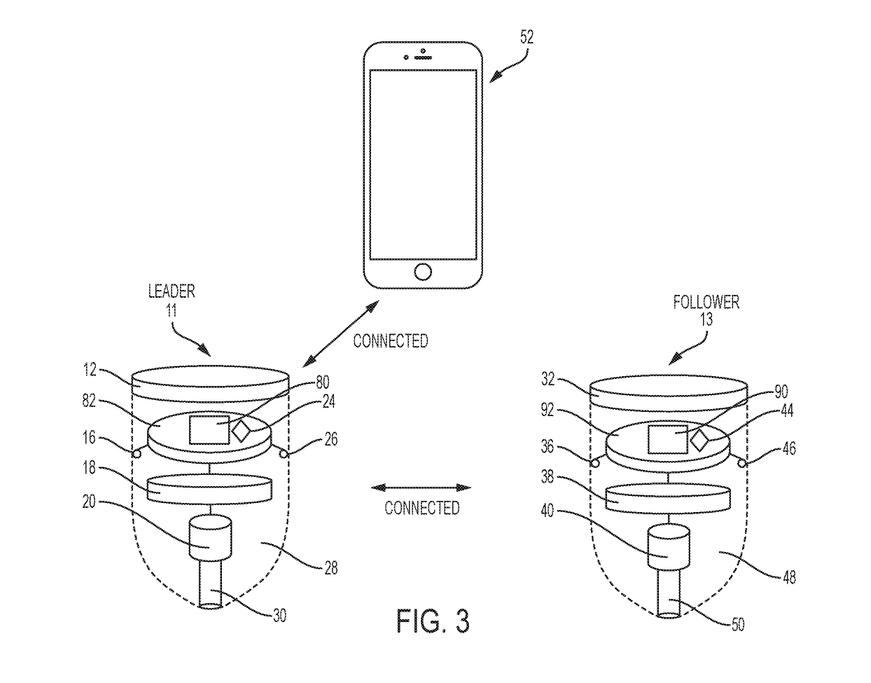

With reference to FIG. 3, the relationship between the two earbuds is now explained according to one embodiment. While the two earbuds are in wireless communication connection with each other, only one of the two earbuds, such as earbud 11, is directly connected to a remote electronic device (smart phone 52) wirelessly, such as via Bluetooth, to receive signals from or transmit signals to the remote electronic device. Therefore, earbud 11 is called the leader. The signals carried over through the primary wireless communication connection between the leader earbud and the remote electronic device may contain audio and/or data to be transmitted by the leader to the follower earbud. The signals may also include audio and/or data to be received from the follower earbud by the remote electronic device, such as audios captured by the follower earbud's microphone. In one embodiment, a secondary wireless communication connection is established between earbuds 11 and 13, which is used to transmit/receive signals between the two earbuds.

In one embodiment, when the leader earbud 11 receives signals from the remote electronic device 52, its controller 80 may process the signals and play the signals in its appropriate format on its speaker 20, such as an audio in MP3 format. If the signals are meant to be played on the other earbud, such as the right channel of a stereo music, the leader earbud 11 transmits the signals to the follower earbud 13 via its established secondary wireless communication connection, such as a Bluetooth connection. Alternatively and/or additionally, the follower earbud 13 may transmit signals back to earbud 11 (e.g., audio captured by microphones 36 and 46 or other control signal/data), and in response, the leader earbud 11 may process the signals received from the follower earbud 13 and transmit to the remote electronic device, as needed.

In one embodiment, when the follower earbud 13 receives signals from the leader earbud 11, it may operate in a similar manner as earbud 11. For example, the controller of earbud 13, i.e. 90, processes the received signals and determines if the signals are audio that should be played to its speaker 40. In one embodiment, the follower earbud 13 may also determine if the signals received from the leader earbud 11 contains a control signal or data. For example, the follower earbud 13 may receive a switching signal indicating that a switching condition has occurred and now that the roles of the leader earbud and follower earbud need to reverse. In response to receiving the switching signal, the controller of the follower earbud 90 may perform appropriate operations or cause various components to perform appropriate operations. For example, the controller 90 may cause the antenna control 59 (FIG. 2) to establish a primary connection with the remote electronic device 52.

In one embodiment, the leader and follower earbuds are made of identical components and the assignment of leader and follower may be random. In another embodiment, the assignment of leader and follower can be based upon which earbud is first powered on. In another embodiment, the assignment can be based on which earbud initially has the most remaining battery charge. In another embodiment, the assignment can be based on which earbud has the strongest antenna reception signal strength level for a communication connection to the same target or remote electronic device.

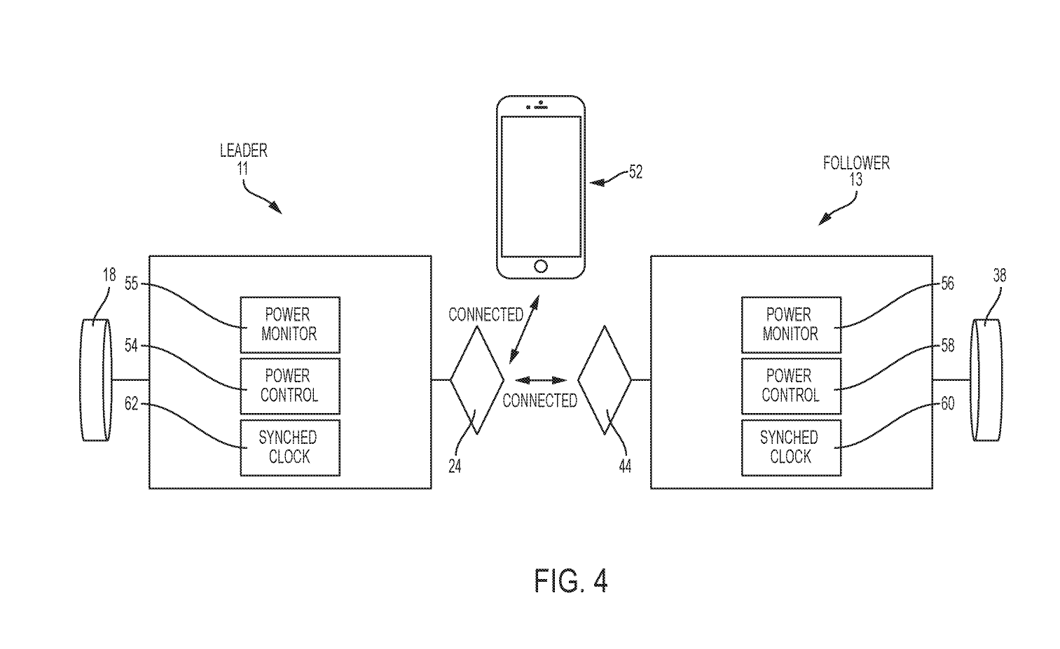

With reference to FIG. 4, now the switching of the roles of leader and follower earbuds is explained. In a non-limiting example, earbud 11 may begin as the leader, establish a primary wireless communication connection, such as a Bluetooth connection, with a smart phone 52, and is configured to transmit signals/data received from the smart phone 52 to the controller 90 of the follower earbud 13, via antennas 24 and 44 and a secondary communication connection. When the power monitor 55 or 56 of either earbud detects that a switching condition has occurred, the controller of leader earbud 11 may determine to reverse the leader and follower relationship of earbuds 11 and 13.

The switching condition indicates that a significant condition has occurred that may warrant a switching of roles of the earbuds in order for the earbud set to continue operating at its optimal performance. For example, a switching condition may be indicative of a threshold drop in the remaining charge level of the battery of one of the earbuds. In another example, the switching condition may be indicative of the existence of a threshold difference (e.g., 25%) in the level of remain battery charges in the two earbuds and when the battery charge level of the leader earbud is lower than that of the follower earbud. This 25% differential represents an example of a threshold, is arbitrary and may be set at any percentage determined sufficient. In another example, the switching condition may be indicative of an elapse of a threshold period of time since a previous switching has occurred, for example, the most recent switching. In one embodiment, the elapse of the threshold period of time may be based on the synchronized clock 62 and 60. For example, synchronized clocks 62 and 60 may communicate elapsed timing to the power monitor system 55 and 56 at fixed intervals (e.g., every 10 elapsed minutes or any percentage or period determined sufficient) to reverse the leader and follower relationship.

Alternatively and/or additionally, the switching condition may be indicative of a threshold drop in the antenna reception signal strength in the leader earbud for the primary communication with the remote electronic device. In one embodiment, the switching condition may also be indicative of the existence of a threshold difference between the antenna reception signal strength of each of the two earbud antennas (e.g., 20 db) for a corresponding communication connection with the remote electronic device and when the antenna reception signal strength of the leader earbud is weaker than that of the follower earbud. In other words, if the antenna monitor system (53 or 57 in FIG. 2) determines that the primary communication connection between the leader earbud and the remote electronic device becomes weaker, or significantly weaker than it would be between the follower earbud and the remote electronic device, then the antenna monitor system may trigger a switching condition. In response, the controller of the leader earbud may trigger a reversal between the leader and follower earbuds. In the event that the antenna reception signal strength of the earbuds fluctuates, the above disclosed switching condition may permit the earbud pair or set to operate at its strongest performance.

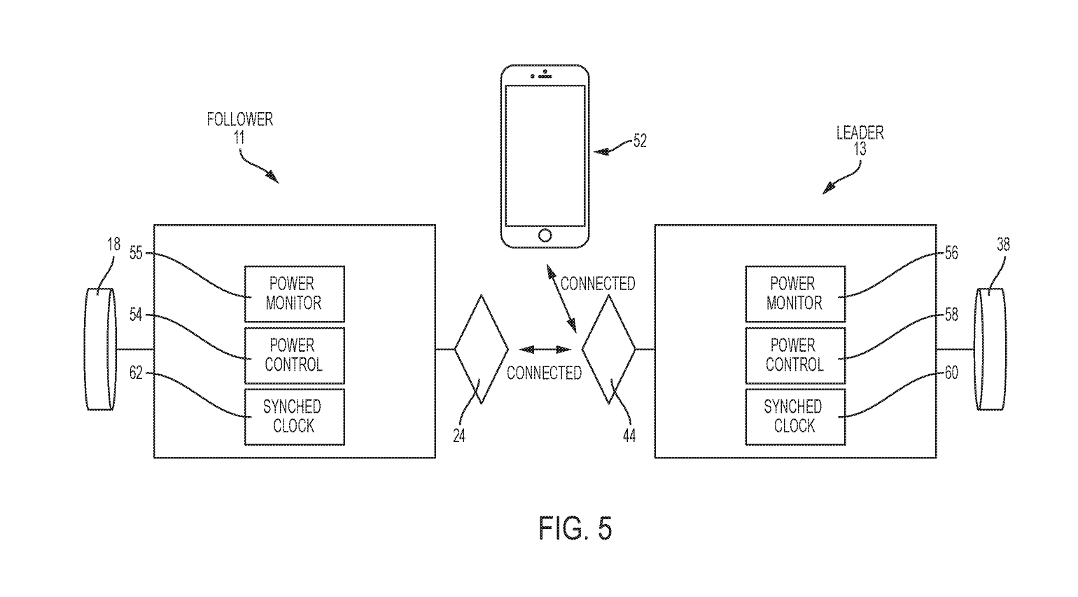

With reference to FIG. 5, once a switching condition is detected, the roles of earbuds 11 and 13 are now reversed, making earbud 11 the follower and earbud 13 the leader. This reversal is achieved by the termination of primary wireless communication connection to the smart phone 52 by earbud 11, establishment of primary connection to smart phone 52 by earbud 13, and the beginning of a direct wireless communication connection between earbud 13 (as leader) and the smart phone 52. The system may do this using any suitable sequence. For example, a diagram showing the switching is described as below according to one embodiment.

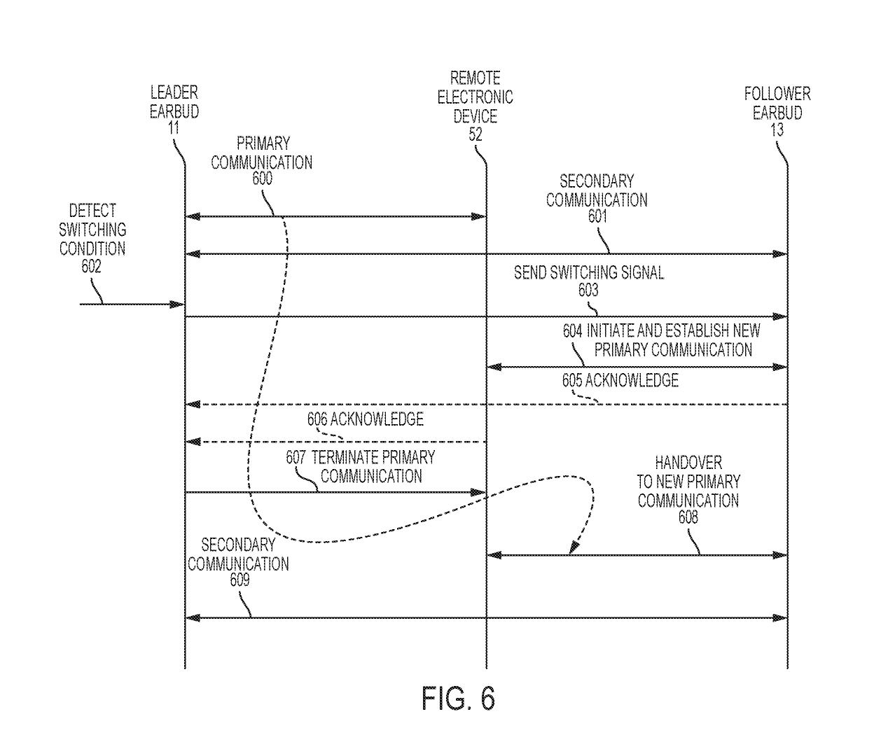

With reference to FIG. 6, in a non-limiting example, earbud 11 starts off as the leader earbud and has established primary communication connection 600 with the remote electronic device 52. Earbud 11 is also in a secondary communication connection 601 with the follower earbud 13 to transmit and receive signals or data to/from earbud 13. When a switching condition has occurred 602, earbud 11 sends a switching signal to the follower earbud 13 to indicate that a switching is to occur. In response, earbud 13 initiates and establishes a new primary communication connection 604 with the remote electronic device 52, and sends back an acknowledgment signal 605 to earbud 11 indicating that earbud 13 is now ready to be the leader earbud. Alternatively and/or additionally, earbud 11 may receive an acknowledgment signal 606 from the remote electronic device 52 indicating that another earbud has established a new primary connection and is ready to take over. Upon receiving the acknowledgement, earbud 11 may now terminate the original primary connection 607 with the remote electronic device 52, and the data transmission between the remote electronic device 52 and earbud 11 is now handed-over 608 to the new primary communication connection between earbud 13 and the remote electronic device 52. Now, earbud 13 is acting as a leader and earbud 11 as a follower, which is in a secondary communication connection 609 with the leader earbud 13.

As can be appreciated by a person ordinarily skilled in the art, there can be various ways to achieve the reversal without departing from the essence of the inventive concepts disclosed in this document. In one embodiment, the hand-shaking/acknowledgement signals may be optional. For example, once the leader earbud has sent out the switching signal to the follower earbud, it may not need to wait for acknowledgment from the follower earbud or the remote electronic device. Instead, it may start terminating the primary communication connection with the remote electronic device and indicate to the remote electronic device that the primary communication connection will be switched to another earbud. Upon receiving the termination request, the remote electronic device may wait for the other earbud to initiate and request a connection, and only upon successful establishment of the new communication connection with the new earbud does the remote electronic device acknowledge the termination request from the leader earbud. In another example, the leader earbud may first terminate the primary communication connection with the remote electronic device, and then send a signal to the follower earbud to establish a new primary communication connection between the follower earbud and the remote electronic device. This simplified signaling may cause a brief loss of signals during the reversal because of lack of hand-shaking. On the other hand, this approach can achieve fast switching with no or minimal latency, and it may be practically reliable when the earbuds are idle or when data communication in the primary communication connection is not time critical.

The above-disclosed features and functions, as well as alternatives, may be combined into many other different systems or applications. Various components may be implemented in hardware or software or embedded software. Various presently unforeseen or unanticipated alternatives, modifications, variations or improvements may be made by those skilled in the art, each of which is also intended to be encompassed by the disclosed embodiments.

1. A method of operating a set of wireless earbuds, comprising:
operating a first earbud and a second earbud, in which each of the earbuds comprises a transmitter, a receiver, and a controller;
by the controller of the first earbud, establishing a primary communication connection between the first earbud and a remote electronic device and a secondary communication connection between the first earbud and the second earbud; and
by the controller of the first earbud, detecting that a switching condition has occurred, and in response:
sending a signal to the controller of the second earbud to establish a primary communication connection between the second earbud and the remote electronic device, and
terminating the primary communication connection between the first earbud and the remote electronic device.

2. The method of claim 1, further comprising, by the controller of the second earbud, establishing the primary communication connection between the second earbud and the remote electronic device in response to receiving the signal.

3. The method of claim 2, further comprising, by the controller of the second earbud detecting that a switching condition has occurred, and in response:
sending a signal to the controller of the first earbud to re-establish the primary communication connection between the first earbud and the remote electronic device; and
terminating the primary communication connection between the second earbud and the remote electronic device.

4. The method of claim 1, wherein detecting that a switching condition has occurred comprises, by a power monitor, detecting that a battery charge level in the first earbud and a battery charge level in the second earbud differ by at least a threshold amount.

5. The method of claim 1, wherein detecting that a switching condition has occurred comprises, by a power monitor, detecting that a battery charge level in the first earbud has decreased by at least a threshold amount as compared to a previous battery charge level.

6. The method of claim 1, wherein detecting that a switching condition has occurred comprises, by the controller of the first or second earbud based on a clock circuit, detecting that a threshold period of time has elapsed since a previous switching has occurred.

7. The method of claim 1, wherein detecting that a switching condition has occurred comprises, by a signal strength monitor, detecting that a level of communication signal strength at the first earbud and a level of communication signal strength at the second earbud for a corresponding communication connection with the remote electronic device differ by at least a threshold amount.

8. The method of claim 7, wherein the level of communication signal strength at the first earbud and the level of communication signal strength at the second earbud are based on a Bluetooth signal strength.

9. The method of claim 1, wherein detecting that a switching condition has occurred comprises, by a signal strength monitor, detecting that a level of communication signal strength at the first earbud for the primary communication connection with the remote electronic device has decreased by at least a threshold amount as compared to a previous communication signal strength level.

10. The method of claim 9, wherein the level of communication signal strength at the first earbud is based on a Bluetooth signal strength.

11. An earbud set comprising:
a first earbud and a second earbud, each comprising a transmitter, a receiver, and a controller;
wherein the controller of the first earbud is configured to:
establish a primary communication connection between the first earbud and a remote electronic device and a secondary communication connection between the first earbud and the second earbud, and
detect that a switching condition has occurred, and in response:
send a signal to the controller of the second earbud to establish a primary communication connection between the second earbud and the remote electronic device, and
terminate the primary communication connection between the first earbud and the remote electronic device;
wherein the controller of the second earbud is configured to:
establish the primary communication connection between the second earbud and the remote electronic device in response to receiving the signal.

12. The earbud set of claim 11, wherein the controller of the second earbud is configured to detect that a switching condition has occurred, and in response:
send a signal to the controller of the first earbud to re-establish the primary communication connection between the first earbud and the remote electronic device; and
terminate the primary communication connection between the second earbud and the remote electronic device.

13. The earbud set of claim 11, wherein each of the first and second earbuds comprises a power monitor configured to detect a battery charge level in each respective earbud, and the switching condition is indicative of a difference between a battery charge level in the first earbud and a battery charge level in the second earbud.

14. The earbud set of claim 11, wherein the first earbud comprises a power monitor configured to detect a battery charge level in the first earbud, and the switching condition is indicative of a decrease of a battery charge level in the first earbud as compared to a previous battery charge level.

15. The earbud set of claim 11, wherein the switching condition is indicative of an elapsed period of time since a previous switching has occurred.

16. The earbud set of claim 11, wherein each of the first and second earbuds further comprises a signal strength monitor configured to detect in each respective earbud a level of communication signal strength for a communication connection with the remote electronic device, and the switching condition is indicative of the difference between a level of communication signal strength at the first earbud and a level of communication signal strength at the second earbud.

17. The earbud set of claim 16, wherein the level of communication signal strength at the first earbud and the level of communication signal strength at the second earbud are based on a Bluetooth signal strength.

18. The earbud set of claim 11, wherein the first earbud further comprises a signal strength monitor configured to detect a level of communication signal strength for the primary communication connection with the remote electronic device, and the switching condition is indicative of a decrease of the level of communication signal strength by at least a threshold amount as compared to a previous communication signal strength level.

19. The earbud set of claim 18, wherein the level of communication signal strength at the first earbud is based on a Bluetooth signal strength.

20. A first earbud comprising:
a transmitter, a receiver, and a controller;
wherein the controller is configured to:
establish a primary communication connection with a remote electronic device and a secondary communication connection with a second earbud, and
detect that a switching condition has occurred, and in response:
send a signal to the controller of the second earbud to establish a primary communication connection between the second earbud and the remote electronic device, and
terminate the primary communication connection between the first earbud and the remote electronic device.

21. The first earbud of claim 20, wherein the controller is also configured to re-establish the primary communication connection between the first earbud and the remote electronic device in response to receiving a switching signal from the second earbud.

22. The first earbud of claim 20, further comprising:
a battery; and
a power monitor configured to detect a charge level in the battery of the first earbud;
wherein the switching condition is indicative of a difference between a charge level of the battery in the first earbud and a charge level of a battery in the second earbud.

23. The first earbud of claim 20, further comprising a power monitor configured to detect a battery charge level in the first earbud, and the switching condition is indicative of a decrease of a battery charge level in the first earbud as compared to a previous battery charge level.

24. The first earbud of claim 20, wherein the switching condition is indicative of an elapsed period of time since a previous switching has occurred.

25. The first earbud of claim 20, further comprising a signal strength monitor configured to detect a level of communication signal strength for the primary communication connection with the remote electronic device, and the switching condition is indicative of a difference between the level of communication signal strength at the first earbud and a level of communication signal strength at the second earbud for a communication connection with the remote electronic device.

26. The first earbud of claim 25, wherein the level of communication signal strength for the communication connection with the remote electronic device at the first earbud and the second earbud are based on a Bluetooth signal strength.

27. The first earbud of claim 20, further comprising a signal strength monitor configured to detect a level of communication signal strength for the primary communication connection with the remote electronic device, and the switching condition is indicative of a decrease of the level of communication signal strength by at least a threshold amount as compared to a previous communication signal strength level.

28. The first earbud of claim 27, wherein the level of communication signal strength for the primary communication connection with the remote electronic device is based on a Bluetooth signal strength.
